(19) United States
(12) Patent Application Publication
(10) Pub. No.: US 2014/0323713 A1
(43) Pub. Date: Oct. 30, 2014

(54) BIO-DEGRADABLE MATERIAL AND METHOD

(71) Applicants: David S. Karpovich, Gagetown, MI (US); Kevin M. Hartman, Somerville, MA (US)

(72) Inventors: David S. Karpovich, Gagetown, MI (US); Kevin M. Hartman, Somerville, MA (US)

(21) Appl. No.: 14/254,298

(22) Filed: Apr. 16, 2014

Related U.S. Application Data
(60) Provisional application No. 61/854,450, filed on Apr. 24, 2013.

(51) Int. Cl. C08B 15/06

(52) U.S. Cl. CPC C08B 15/06
USPC 536/30

(57) ABSTRACT

The invention comprises a method of preparing moldable biodegradable composites containing a diamine cross-linked cellulose alkyl ester. The novel composite can be compression molded to form biodegradable composite (materials)s in the form of useful articles such as cups, planters and the like.

### CROSS REFERENCE TO RELATED APPLICATIONS

This application claims the benefit of the filing date of U.S. Provisional Application No. 61/854,450 filed Apr. 24, 2013, the teachings of which are incorporated herein by reference.

### ACKNOWLEDGEMENT OF GOVERNMENT SUPPORT

The invention was made with government support under National Science Foundation Grant No. CHE 959888, Major Research Instrumentation-Reinvestment and Recovery Act. The Government has certain rights in the invention.

### BACKGROUND Of THE INVENTION

The invention is a relatively inexpensive method for preparing bio-degradable composites, novel bio-degradable materials, and articles prepared there from.

Large amounts of natural organic wastes are created daily. Typically, these wastes are burned or buried to dispose of them. It has become environmentally and economically necessary to consider ways in which these wastes can be removed from the environment and turned into useful products.

Polysaccharides are major constituents of these natural organic materials. As used in this patent application “polysaccharide” means a substantially pure carbohydrate, such as starch or cellulose and materials containing a polysaccharide as a major component, such as pulp, the major component of which is cellulose. Polysaccharides are increasingly used as a source of raw material for the chemical industry whereby they are converted to useful products. Examples of such materials include the processing of novel materials from wood cellulose, hemicelluloses of straw, grass, leaves, fruits and vegetables, and starch of cereals and tubers.

### SUMMARY OF THE INVENTION

The invention comprises a method of preparing a moldable biodegradable composite containing a diamine cross-linked cellulose amide. The novel composite can be compression molded to form biodegradable composites (materials) in the form of useful articles such as cups, planters and the like. The method comprises: a. forming a dispersion of fine particles of at least one polysaccharide, b. converting pendant hydroxyl groups on carbon atoms of the anhydroglucose unit of the polysaccharide to polysaccharide carboxylate groups at a sufficiently low temperature and absence of chemicals such that the carbon—carbon bonds that form the ring of the anhydroglucose units of the polysaccharide are not broken, c. removing substantially all water from the product of step b, d, reacting the product from step b in a Fischer-Speier reaction employing a low molecular weight alcohol and an acid catalyst while simultaneously removing water from the reaction to form a cellulose alkyl ester substantially free of water, and e. cross-linking the cellulose alkyl ester with a diamine in alcohol solution to form a cross-linked cellulose amide composite material. Fischer-Speier, also know as Fischer esterification, is an acid catalyzed nucleophilic acyl substation which involves the conversion of a carboxylic acid or carboxylate to an ester using an alcohol. The water can be removed from step b. for example by centrifuge, or filtration (vacuum, pressure or gravity). If desired the carboxylic acid form of the material formed in step b. can be produced from the carboxylate by treating the material first with sulfuric acid (or any other acid) and then the carboxylic acid material subjected to the Fischer Esterification step of step d.

U.S. Pat. No. 8,299,172 teaches a method for producing biodegradable plastics from natural materials containing polysaccharides using a basic aqueous solution containing proteins and polysaccharide treated to form carboxyl groups without opening the ring structure of the polysaccharide.

Examples of reactants for the carboxylating process (step b. above) in this invention include but are not limited to reagents such as hypochlorite, acylating agents, and carboxymethylating agents. Hypochlorite and similar agents convert primary alcohols (e.g., C6 of the anhydroglucose unit of the polysaccharide) to carboxylates, whereas acylating agents, such as anhydrides, create an ester with the carboxyl function. Further, carboxymethylation with reagents such as chloroacetic acid forms an ether bond with the carboxyl function. The latter is exemplified by the well-known commercial product carboxylmethylcellulose. The carboxylating process does not include periodate oxidation, which produces only dialdehyde polysaccharide, which is known in the field and does not produce carboxylates through the chemistries in this patent.

An objective of the invention described herein provides a robust manufacturing process capable of accepting a wide range of feedstock raw materials, including common polysaccharides in abundance as industrial waste materials or by-products. Examples of such raw materials are described below and include ethanol distillers' grain, sugar beet pulp, sawdust, and corncob.

Distiller's grain is a by-product or waste product from manufacturing ethanol from crops including corn. Significant growth in the worldwide production of distiller's grain is anticipated because of rapid growth in the mass production of corn-derived ethanol for transportation fuel. The main use of this material is as an animal feed. It can also be incorporated into human snack food and spaghetti, and in one instance, it has been reported as an extender and thickener in urea-formaldehyde plywood adhesives.

Also, corncobs are usually considered waste material from industrial utilization of maize crops. Several applications of corncobs have been reported in the literature. Pulverized corncobs were admixed with various glues and petroleum-derived fibers to produce lignocellulosic composites. Polypropylene and other engineering polymers have been reinforced with pulverized corncob fiber and attempts to use shredded corncobs in paper making have also been published.

Corncobs contain approximately 47% by weight cellulose in their woody fraction, and 36% cellulose in the pith and chaff fraction. In fractions, approximately 37% by weight hemicelluloses and 35 to 36% by weight pentosans exist.

Sawdust, which is a voluminous waster material of the forest products industry, can also be employed.

There are many other natural sources of polysaccharides including leaves, bark, roots, straw, shells of seeds, and stems of plants, microalgae, and especially sugar beet pulp as a large volume by-product from the production of sugar from sugar beets. Although a large amount of this pulp is utilized as animal feed, the production of L-arabinose, and the production of paper, this utilization is not enough to significantly reduce this by-product.

### BRIEF DESCRIPTION OF THE DRAWINGS

FIG. 1 shows a schematic illustration of one embodiment of the method of the invention.

FIGS. 2 and 3 graphically illustrate how strength and density of a few example formulations of the invention depend on crosslinking and molding pressure taken from Tables 2 and 3 herein after.

### DETAILED DESCRIPTION OF THE INVENTION

The invention comprises a method of preparing moldable biodegradable composites containing diamine cross-linked cellulose. The novel composite can be molded to form biodegradable composite (material) can be thermoformed and molded to prepare useful articles such as cups, planters and the like. The method comprises: a. forming a dispersion of fine particles of at least one polysaccharide: b. converting pendant hydroxyl groups on carbon atoms of the anhydroglucose unit of the polysaccharide to polysaccharide carboxylate groups at a sufficiently low temperature and absence of chemicals such that the carbon—carbon bonds that form the ring of the anhydroglucose units of the polysaccharide are not broken: c. removing substantially all water from the product of step b, d. reacting the product from step b. in a Fischer-Speier reaction employing a low molecular weight alcohol and an acid catalyst while removing water from the reaction to form a cellulose alkyl ester substantially free of water, and e. cross-linking the cellulose alkyl ester with a diamine in alcohol solution to form a cross-linked cellulose amide composite material.

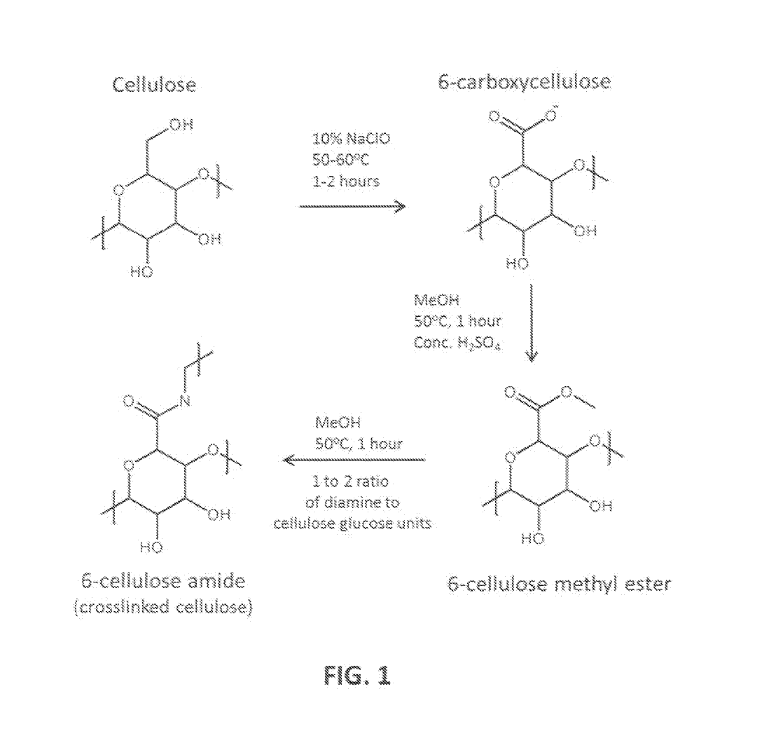

A particulate polysaccharide is dispersed in an aqueous solution. The dispersion is subjected to a carboxylating process that converts any hydroxyl group on any carbon atom of the anhydroglucose units of the polysaccharide to a carboxylate under conditions that do not break the carbon—carbon bonds that form the anhydroglucose unit of the polysaccharide, forming a polysaccharide carboxylate (corresponding to FIG. 1). The process subsequently entails removing water from the carboxylate dispersion and reacting the carboxylate in a Fischer-Speier reaction process employing a low molecular weight alcohol and an acid catalyst while removing water formed from the reaction to form a cellulose alkyl ester substantially free of water. The alkyl ester is then cross linked with a diamine to crosslink the cellulose alkyl ester cellulose molecules to form a material than can be thermo formed to prepare useful articles. The process is schematically illustrated in FIG. 1. The invention is not limited to the specific reaction conditions set forth but are illustrative of an embodiment of the invention only.

With more specifically, this invention describes a method to prepare biodegradable materials, the method comprising (I) providing a suspension in a aqueous carrier of a finely divided natural material containing polysaccharides, (II) agitating the suspension for a period of time and then, (III) subjecting the product resulting from step (II) to a carboxylating agent that converts any pendant hydroxyl group on any carbon atom of the anhydroglucose units of the polysaccharide chain to a carboxylate, forming polysaccharide carboxylate. The carboxylating agent can be selected from the group comprising: (A) acylation using materials selected from a group comprising cyclic anhydrides of (i) maleic acid, (ii) succinic acid, (iii) glutaric acid, (iv) phthalic acid, and (v) derivatives of (i), (ii), (iii), and (iv); (B) carboxymethylation using materials selected from the group comprising: (i) haloalkanoic acids and (ii) salts of haloalkanoic acids such as NaClO, and, (C) oxidation using an oxidizing agent selected from the group comprising (a) hypochlorites, (b) hydrogen peroxide, (c) ozone and (d) air, to provide a solid anionic material.

Water is removed from the material resulting from (III), and IV the material is reacted in a Fischer-Speier reaction (FS) employing a low molecular weight alcohol and an acid catalyst to form a cellulose alkyl ester. Examples of alcohols include C1 to C3 alcohols, such as methanol, ethanol and isproponal. Preferred are shorter chain alcohols because they serve as more effective leaving group for the amidation reaction step. Acid catalysts are those know for the FS reaction such as sulfuric, toluenesulfonic acid (tosic acid) and Lewis acids. Water which is generated during this reaction is preferably removed during the reaction employing for example molecular sieves or a drying agent such as sodium sulfate. Azeotropic distillation or other appropriate methods can also be employed to remove the water. The alcohol should be used in great excess to drive the esterification reaction and also act as a solvent for the system. A ratio of one (1) gram starting material and from about 1 to 10 mL, of methanol is an example of a suitable reaction mixture. The catalyst can be for example sulfuric acid in an amount of about 250-500 μl.

Thereafter, there is a step (V) of adding a diamine directly to the material dispersion of the previous step to crosslink the cellulose alkyl ester. A ratio of two cellulose monomer units to one diamine molecule can be used. Primary diamines cross-link most efficiently under the conditions described here. Secondary diamines can also be used. Examples of useful diamines include branched and linear primary diamines, xylyenediamines and aromatic diamines. Specific diamines that are useful include for example C2-C6 linear aliphatic diamines such as ethylene diamine; branched aliphatic diamines such as, 1,2-diaminopropane, diphenylethylenediamine, diaminocyclohexane; xylylenediamines such as o-xylylenediamine, m-xylylenediamine; aromatic diamines such as, o-phenylenediamine, m-phenylenediamine, p-phenylenediamine, 2,5-diaminotoluene, 4,4′-diaminobiphenyl and 1,8-diaminonaphthaline. Secondary diamines include for example N,N′-dimethylethylenediamine. Preferred are linear aliphatic primary diamines.

The final crosslinked composite material resulting from (V) is dried with a drying technique such as air drying, oven drying, spray drying, supercritical CO₂ drying, solvent dehydration, or a combination thereof. The resulting material from step (V) can be molded into a shaped component and subsequently dried into a final, solid shape. Alternatively, the dried material in step (V) can be mechanically molded by conventional plastic equipment.

An alternate embodiment forms the resulting liquid materials in step (V) into thin sheets by conventional papermaking technology, where the thin sheets are formed by drainage of a fibrous-material suspension on a screen or between two continuously revolving screens. Alternatively, prior to advancing to a manufacturing step liquid materials produced in step (V) can also be applied as an adhesive film to bond various materials together including paper, wood, metal, glass, and ceramics.

The method of this invention applies to a wide range of natural polysaccharide materials. The materials can be, for example, starchy materials, cellulose materials, lignocellulose materials, hemicellulosic containing materials, and plant gum containing materials. Included in, but not limited to, are the polysaccharide-containing materials such as plant tubers, wheat, seed, shells of seeds, stems, roots, and leaves of plants, fruits and their skins, wood, tree branches tree bark, straw, grass, and waster materials originating from the agricultural industry, for example, distiller's dry grain, sugar beet pulp, cellulose pulp, paper waste, cotton, linen, vegetables and vegetable waste, such as tomato skins and seeds, and the like.

According to the method, polysaccharide materials are pulverized, ground, or minced, to render them into smaller particle sizes and then the particulate material is suspended in an aqueous solution which is then agitated at room or elevated temperatures. While any size of particle can be used, smaller particles result in greater surface area for reactions which leads to more crosslinking, greater heterogeneity of the material, and greater strength. The commercially available microcrystalline cellulose feedstocks used for examples herein had an approximate range of particle sizes from less than one to several hundred micrometers in diameter whereby much larger particle sizes are typical for raw, natural polysaccharide containing materials.

Thereafter, the saccharide component in the agitated suspension is subjected to a carboxylating process that reacts with pendant hydroxyl groups at any carbon atom of the anhydroglucose units of the polysaccharide to form polysaccharide carboxylates. For this invention, “carboxylating process” means any process or agent converting any existing pendant hydroxy group ion the anhydroglucose units of the saccharide to a carboxylate without breaking any of the carbon to carbon bonds of the anhydroglucose units of the saccharide. The concentration of the carboxylating reactant should correspond to that resulting from the stoichiometry of reactions used to carboxylate the pendant hydroxy groups of the anhydroglucose units in the saccharide reaction mass. The greater the concentration of the polysaccharide dispersion, the greater the production of polysaccharide carboxylate. There are no set limits on the concentration of the polysaccharide dispersion other than what is practical for yield for lower concentrations and ability to mix for higher concentrations. These practical limits will depend on the specific polysaccharide material used and its particle sizes.

Methods of carboxylating pendant hydroxy groups in the anhydroglucose units of the polysaccharide include (i) acylation by reaction with the cyclic anhydrides described Supra, and derivatives of such anhydrides, (ii) carboxymethylation with haloalkanoic acids and their salts, for example, chloroacetic acid, bromosuccinic acid, iodomalonic acid, and the like, and (iii) oxidation of the material with an oxidizing agent that does not cleave the C2-C3 bonds of the anhydroglucose unit of the polysaccharide, for example, hypochlorites, hydrogen peroxide, ozone, or air.

The resulting wet paste from the crosslinking step then undergoes a procedure for plastic shaping. It can be directly shaped by hand molding or by injection into a forming die and subsequently dried into a hard material, or, the west paste can be dried into hard fragments, subsequently pulverized into a powder, and then subsequently reconstituted into paste by adding water, and subsequently molded and/or injected into a forming die.

Also contemplated within the scope of this invention is using a dry film evaporator or a spray dryer to reduce the water in the product prior to molding. Also contemplated within the scope of this invention is using conventional plastic thermoforming equipment, such as an injection molder or a compound extruder, to mold the dried composite.

In the following example samples of precursors and prepared crosslinked materials were evaluated using various techniques as explained under the heading EXAMPLES.

### EXAMPLES

In each of the following examples the conditions used to prepare examples of the moldable material were those shown in FIG. 1.

### Equipment Used

General glassware

Stir Bars (Overhead stirring for fibrous materials (cotton, algae, etc)

Hot plate and/or Heating Mantle

Centrifuge

Ground material powder was pressed at 15,000 psi

Differential Scanning Calorimeter (DSC), Thermogravimetric Analysis (TGA), Fourier Transform Infrared Spectroscopy (FTIR), Raman, and Strength measurements for the following compounds were obtained:

### Precursor 1: Cellulose

### Precursor 2: Oxidized Cellulose

### Precursor 3: Cellulose Methyl Ester

### Example 1

Cellulose Crosslinked with Ethylenediamine

### Example 2

Cellulose Crosslinked with Diaminobutane

### Example 3

Cellulose Crosslinked with Diaminohexane
Strength measurements for the following additional compounds were also obtained.

### Example 4

Cellulose Crosslinked with Urea

### Example 5

Cellulose Crosslinked with p-Phenylenediamine

### Example 6

Cotton Crosslinked with Diaminohexane

### Example 7

Algae Crosslinked with Diaminohexane
and precursor and examples of materials were treated with heat, vacuum, water and different pressures.

Additional starting materials that can be used include waste paper, and corn cob powder. Additional crosslinking agents that can be utilized include ammonia, o-Phenylenediamine, and Ethylenediamine tetraacetic acid.

In the first step, 20 grams of polysaccharide containing material (microcrystalline cellulose in each example) was reacted with 200 mL of 10% by weight sodium hypochlorite solution. This mixture was stirred at 50 degrees Celsius for one hour. The beginning appearance of the NaClO solution with starting material was a yellow color, and the reaction was considered complete when the solution became colorless and the cellulose became a brilliant white. (Non-white starting materials (algae) will not be the brilliant white). The presence of the carboxylate was confirmed by both IR and Raman.

The material remained in the solid phase throughout the entire process. The carboxylated polysaccharide initially dispersed in hypochlorite solution and was centrifuged and the supernatant solution decanted. The carboxylated polysaccharide was then washed with 50 mL of pure deionized water, shaken, and centrifuged twice, followed by one washing cycle with methanol.

The primary —OH group at carbon 6 of the glucose monomer was oxidized. There are two secondary —OH groups on each subunit, however they are part of the ring structure and oxidation to carboxylate would generate a ketone, or require the breaking of the ring itself and create an aldehyde. No aldehyde or ketone formation was shown by spectroscopy.

Fischer Esterification is a well understood reaction. The carboxylated polysaccharide solid washed with methanol following the first step is mixed in 200 mL of fresh methanol and 4 grams of 4 Å molecular sieves to remove any residual water, and to eliminate water formed during the esterification reaction to drive the reaction towards the ester., Concentrated sulfuric acid was added to the mixture to act as a catalyst (2 mL). The reaction was carried out at 50°-60° C. (methanol boils at 65° C.) in methanol with stirring for approximately 1 hour.

The reaction itself is an esterification reaction of a carboxylic acid and an alcohol, using the sulfuric acid as a catalyst. Different alcohols can be used during this step: however methanol provides a very effective leaving group. Larger alcohols, while still able to be used, would discourage the crosslinking step. Several different acid catalysts can be used for the reaction. Sulfuric acid, tosic acid, and Lewis acids are preferred commonly used.

After the mixture has reacted for approximately 1 hour, and the ester has formed the diamine is added to the solution directly at a ratio of 2 cellulose monomer units to 1 diamine molecule. For example, about 4 mL of ethylen diamine would be added to the ester product from above. Other ratios may vary the amount of crosslinking and branching. Non-linear diamines can be used, such as p-pheylenediamine.

### DSC Data

Samples for DSC were cooled to −20° C. and heated at a rate of 10° C./min to a temperature of 300° C., both in hermetically sealed pans, and in open pans to allow for the evaporation of bound water. Samples were run on a TA Instruments Q2000 DSC and analyzed using Universal Analysis.

DSC results of Sealed Samples are shown in Table 1. The largest transition of the sealed samples in each case is that of the vaporization of the bound water, many of these displaying the signature reduction of temperature during the transition. Of the samples tested, the oxidized cellulose binds the water tightest, with the vaporization not occurring until —210° C., while cellulose ester contains the most bound water. In the final biomaterials, by increasing the chain length of the crosslinker, both the amount of bound water decreases, and how tightly it is bound to the material making the material more hydrophobic. Prior to the main water transition there are few thermal transitions. Specifies would include the endothermic event at ˜100° C. for the ethylenediamine material, and the glass transition of cellulose and the biomaterials. A rather large exothermic event occurs in the cellulose methyl ester, with the main water vaporization occurring during its tail end. The other smaller endothermic events are all sharp transitions, which could be small amounts of bound water vaporizing.

DSC results of Open Samples are also shown in Table 1. In the open pan samples, the bound water is allowed to escape upon heating, and would account for the initial drop in heat flow up to 100° C. The absence of the bound water peaks gives transitions specific to the materials themselves. The endothermic event present for the ethylenediamine material in the sealed pans is still present in the absence of water, as is the later endothermic events of the biomaterials crosslinked with diaminobutane and diaminohexane. The longer chained crosslinker, the greater in temperature the endothermic event is occurring.

TABLE 1
Results of Differential Scanning Calorimetry analysis
of examples of the invention. Thermal events,
temperatures, and enthalpy changes in the materials are
noted. Glass transition events are indicated in bold type.

| Open Samples | | | |
|---|---|---|---|
| Sample | Temp | Enthalpy | Event |
| Precursor 2: Oxidized | 182.5 | −56.17 | Thermal Event |
| Cellulose | | | 1 |
| Example 1: Ethylenediamine | 119.36 | 32.34 | Thermal Event |
| Polymer | | | 1 |
| Example 1: Ethylenediamine | 236.125 | 14.1 | Thermal Event |
| Polymer | | | 2 |
| Example 1: Ethylenediamine | 286.7 | 93.28 | Thermal Event |
| Polymer | | | 3 |
| Example 2: Diaminobutane | 142.53 | −29.52 | Thermal Event |
| Polymer | | | 1 |
| Example 2: Diaminobutane | 251.06 | 71.77 | Thermal Event |
| Polymer | | | 2 |
| Example 3: Diaminohexane | 131.26 | −19.21 | Thermal Event |
| Polymer | | | 1 |
| Example 3: Diaminohexane | 282.02 | — | Thermal Event |
| Polymer | | | 2 |

Water Vaporization

| Sample | Temp |
|---|---|
| Precursor 1: Cellulose | >200 |
| Precursor 2: Oxidized Cellulose | 214.68 |
| Precursor 3: Cellulose Ester | 190.87 |
| Example 1: Ethylenediamine Polymer | 199.14 |
| Example 2: Diaminobutane Polymer | 191.69 |
| Example 3: Diaminohexane Polymer | 177.8 |

Sealed Samples

| Sample | Temp | Enthalpy | Event |
|---|---|---|---|
| Precursor 1: Cellulose | 128.58 | | Tg |
| Precursor 1: Cellulose | 152.22 | 2.942 | Water |
| Precursor 1: Cellulose | 165.16 | 0.4267 | |
| Precursor 2: Oxidized Cellulose | 144.57 | 0.7643 | Water |
| Precursor 2: Oxidized Cellulose | 155.14 | 3.645 | Water |
| Precursor 2: Oxidized Cellulose | 188.47 | 0.7687 | Water |
| Precursor 3: Cellulose Ester | 155.92 | 8.171 | Water |
| Precursor 3: Cellulose Ester | 178.99 | −364.4 | Large Exo |
| Example 1: Ethylenediamine | 57.55 | | Tg |
| Polymer | | | |
| Example 1: Ethylenediamine Polymer | 112.65 | 6.860 | |
| Example 1: Ethylenediamine Polymer | 141.81 | 0.4741 | Water |
| Example 1: Ethylenediamine Polymer | 157.09 | 3.727 | Water |
| Example 1: Ethylenediamine Polymer | 164.68 | 8.393 | |
| Example 2: Diaminobutane Polymer | 51.56 | | Tg |
| Example 2: Diaminobutane Polymer | 147.05 | | Tg |
| Example 2: Diaminobutane Polymer | 163.25 | 1.84 | |
| Example 3: Diaminohexane Polymer | 63.48 | | Tg |
| Example 3: Diaminohexane Polymer | 149.76 | | Tg |
| Example 3: Diaminohexane Polymer | 156.84 | 2.063 | |

“Large Exo” in Table 1 above means Large Exotherm.
Temperatures are Centigrade
No entries in Second column means not determined
Enthalpy is units of Joules/gram (J/g)

### Tensile Strength

The strength measurements on various materials including examples of the invention were carried out using a 1.27 cm cylindrical die where 0.5 g of powdered material was added. The die was placed on a carver press and held at 15.000 psi for 5 minutes. The resulting pellets were then loaded on an Instron on their edge and pressure applied to determine their fail point. Tensile strength was determined using the following equation:

$$Tenslie Strength = \frac{Applied Load ( N )}{Volume of the Disk ( {m}^{3} )}$$

The results are shown in Table 2 below. The strength measurements can vary greatly depending on several factors such as degree of crosslinking, particle size, pressures used, and pretreatment conditions. Table 3 indicates densities and strengths of cellulose and the ethylenediamine polymer that were pressed at varying pressures, as well as ethylenediamine polymer that was pretreated to give varying degrees of water present in the samples, as well as samples pretreated with heat. Through analysis of the strength data, there is an inverse relationship between the length of a linear crosslinker and the resulting strength of the material. There is also a direct relationship between the pressures used to form the pellets and their resulting strength.

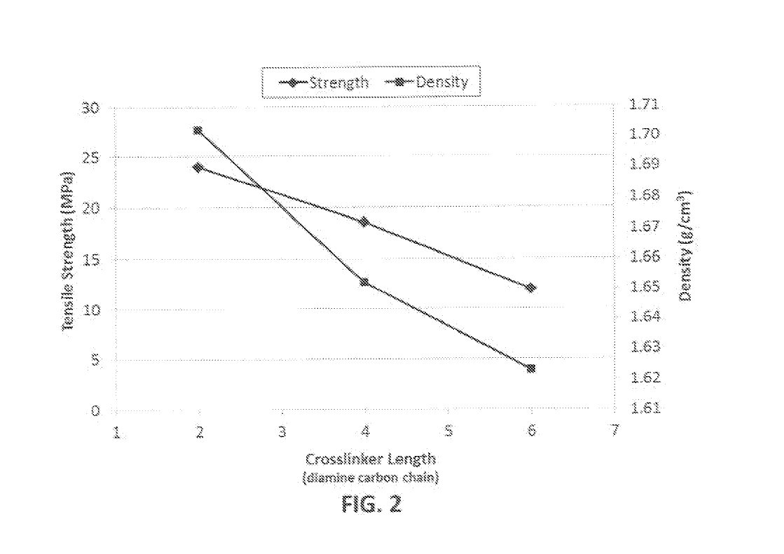

TABLE 2
Strengths and densities of example materials molded at 15,000
psi. The results in bold represent variation in crosslinker carbon
chain length, and these are graphically shown in FIG. 2.

| | Strength | Density |
|---|---|---|
| Sample | (MPa) | (g/cm\hat{ }3) |
| Precursor 1: Cellulose | 13.362 | 1.549 ± 0.1 |
| Precursor 2: Oxidized Cellulose | 15.504 | 1.564 ± 0.1 |
| Precursor 3: Cellulose Methyl Ester | 12.513 | 1.700 ± 0.1 |
| Example 1: Cellulose Ethylenediamine Polymer | 23.943 | 1.702 ± 0.1 |
| Example 2: Cellulose Diaminobutane Polymer | 18.588 | 1.652 ± 0.1 |
| Example 3: Cellulose Diaminohexane Polymer | 11.903 | 1.623 ± 0.1 |
| Example 4: Cotton Diaminohexane Polymer | 13.278 | 1.725 ± 0.1 |
| Example 5: Algae Diaminohexane Polymer | 14.514 | 1.631 ± 0.1 |

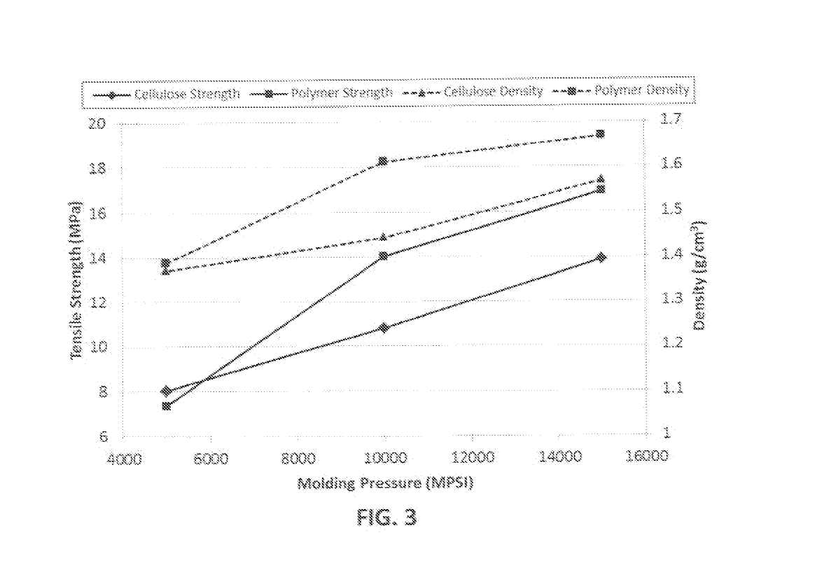

TABLE 3
Strengths and densities of example materials prepared
under various processing conditions. The results shown
in bold represent variation in molding pressure, and
these are also shown graphically in FIG. 3.

| | Strength | Density |
|---|---|---|
| Ethylenediamine Polymers | (MPa) | (g/cm\hat{ }3) |
| EDA Polymer Pressed at 15,000 psi | 16.876 | 1.664 |
| EDA Polymer Pressed at 10,000 psi | 14.021 | 1.611 |
| EDA Polymer Pressed at 5,000 psi | 7.356 | 1.388 |
| EDA Polymer Treated at 100 C. for 1 hour | 9.271 | 1.580 |
| EDA Polymer Treated at RT under vacuum | 16.895 | 1.567 |
| overnight | | |
| EDA Polymer Treated in water overnight, air | 17.295 | 1.557 |
| dried | | |
| EDA Polymer Treated at 160 C. for 1 hour | 10.884 | 1.436 |
| Cellulose Pressed at 15,000 psi | 13.875 | 1.567 |
| Cellulose Pressed at 10,000 psi | 10.797 | 1.442 |
| Cellulose Pressed at 5,000 psi | 8.018 | 1.370 |

### IR Data

The IR data was collected over 128 scans from 700 to 4000 wave numbers. The raw data was subjected to normalization to C-H stretches and baseline corrected. IR data for cellulose, the oxidized cellulose, cellulose methyl ester, and the linear diamine examples are given in Table 4. Data points shown are only from peaks in the range of 700-2000 cm⁻¹. The signature amide peaks are highlighted in bold in Table 4. The specific amide peak should range from 1500-1550 cm⁻¹. The amide bond can be easily detected by both IR and Raman; however each has their own interferences. One of the two amide peaks can be masked by the presence of water, which has a peak at 1640 cm−1, Raman has no interference from water, however many of these final materials fluoresce and cause interference in the Raman spectrum.

TABLE 4
IR peak positions (in wavenumber, cm⁻¹) and absorbances
for major peaks from ATR-IR spectra taken of precursors
and examples. Amide peaks are highlighted in bold.
IR Data

| Precursor 1: Cellulose | | Precursor 2: Oxidized Cellulose | | Precursor 3: Cellulose Ester | |
|---|---|---|---|---|---|
| Peak | Wave | Peak | Wave | Peak | Wave |
| Intensity | number | Intensity | number | Intensity | number |
| (absorbsnce) | (cm⁻¹) | (absorbsnce) | (cm⁻¹) | (absorbsnce) | (cm⁻¹) |
| 0.00452778 | 1633-1653 | 0.003654328 | 1714-1734 | 0.01268 | 1747-1767 |
| 0.016109366 | 1410-1430 | 0.008154565 | 1650-1670 | 0.01527 | 1706-1726 |
| 0.023067849 | 1357-1377 | 0.010793802 | 1614-1634 | 0.00838 | 1623-1643 |
| 0.025284078 | 1313-1333 | 0.016850513 | 1413-1433 | 0.00851 | 1420-4440 |
| 0.048447249 | 1150-1170 | 0.021384587 | 1355-1375 | 0.01317 | 1360-1380 |
| 0.083358818 | 1100-1120 | 0.024023824 | 1305-1325 | 0.0234 | 1303-1323 |
| 0.156947162 | 1040-1060 | 0.055187122 | 1147-1167 | 0.09084 | 1150-1170 |
| 0.141362066 | 1020-1040 | 0.086621111 | 1100-1120 | 0.08733 | 1100-1120 |
| 0.017062582 | 890-910 | 0.149590598 | 1040-1060 | 0.14312 | 1047-1067 |
| | | 0.032110716 | 894-914 | 0.14475 | 1023-1043 |
| | | | | 0.05704 | 880-900 |

| Example 1: | | Example 2: | | Example 3: | |
|---|---|---|---|---|---|
| Ethylenediamine Polymer | | Diaminobutane Polymer | | Diaminohexane Polymer | |
| Peak | Wave | Peak | Wave | Peak | Wave |
| Intensity | number | Intensity | number | Intensity | number |
| 0.01085329 | 1623-1643 | 0.003617796 | 1730-1750 | 0.002762241 | 1733-1753 |
| 0.011726757 | 1523-1533 | 0.009672844 | 1620-1640 | 0.01556501 | 1610-1630 |
| 0.007192163 | 1440-1460 | 0.010053664 | 1505-1525 | 0.01574039 | 1510-1530 |
| 0.006393034 | 1360-1380 | 0.010396403 | 1420-14440 | 0.008505949 | 1454-1464 |
| 0.00806563 | 1326-1346 | 0.013709542 | 1357-1377 | 0.007979808 | 1357-1377 |
| 0.155347003 | 1060-1080 | 0.016108712 | 1313-1333 | 0.009339006 | 1315-1335 |
| 0.048672545 | 980-1000 | 0.079667672 | 1147-1167 | 0.062698489 | 1225-1245 |
| | | 0.109219351 | 1100-1120 | 0.148503345 | 1128-1148 |
| | | 0.156441107 | 1040-1060 | 0.125090063 | 1100-1120 |
| | | | | 0.124783147 | 1140-1160 |
| | | | | 0.157842351 | 990-1010 |

### Raman Data

The Raman data was collected over 20 scans from 250 to 3100 wave numbers using 5 second pulses at a wavelength of 784 nm and laser intensity of 400 mW. The raw data was processed by subtracting a baseline across the spectrum using the analysis software Origin 8.5 to remove fluorescence background signal. The data was then normalized C-H stretch at 2870-2900 cm⁻¹. The Raman data of the linear diamine examples and the Raman data for cellulose, the oxidized cellulose, and cellulose methyl ester are set forth in Table 5. Data points shown are only from 500-1850 cm⁻¹. The carboxylate as well as the signature amide peak are indicated in bold. The specific amide peak should range from 1600-1650 cm⁻¹. The amide bond can be easily detected by both IR and Raman; however each has their own interferences. While there is no signal overlap from bound water, the majority of the raw signal of the polymers (especially with darker colored samples) is in fluorescence and the Raman peaks can only be distinguished if they are of substantial intensity.

TABLE 5
Raman peak positions (in wavenumber, cm⁻¹ for major peaks from
spectra taken of precursors and examples. Carboxylate Peaks are
highlighted in bold. Amide peaks are highlighted in underlined bold.
Raman Peak Ranges

| | | |
|---|---|---|
| Precursor 1: | Precursor 2: | Precursor 3: |
| Cellulose | Oxidized Cellulose | Cellulose Ester |

| | | | | | |
|---|---|---|---|---|---|
| 322 | 342 | 322 | 342 | 330 | 350 |
| 341 | 361 | 340 | 360 | 343 | 363 |
| 370 | 390 | 370 | 390 | 369 | 389 |
| 426 | 446 | 427 | 447 | 426 | 446 |
| 448 | 468 | 448 | 468 | 448 | 468 |
| 482 | 502 | 481 | 501 | 483 | 503 |
| 509 | 529 | 509 | 529 | 508 | 528 |
| 558 | 578 | 557 | 577 | 408 | 428 |
| 566 | 586 | 566 | 586 | 560 | 580 |
| 584 | 604 | 584 | 604 | 579 | 599 |
| 599 | 619 | 600 | 620 | 598 | 618 |
| 715 | 735 | 716 | 736 | 886 | 906 |
| 887 | 907 | 887 | 907 | 958 | 978 |
| 959 | 979 | 960 | 980 | 986 | 1006 |
| 987 | 1007 | 987 | 1007 | 1027 | 1047 |
| 1028 | 1048 | 1027 | 1047 | 1045 | 1065 |
| 1048 | 1068 | 1049 | 1069 | 1085 | 1105 |
| 1086 | 1106 | 1086 | 1106 | 1111 | 1131 |
| 1110 | 1130 | 1111 | 1131 | 1141 | 1161 |
| 1139 | 1159 | 1141 | 1161 | 1193 | 1213 |
| 1191 | 1211 | 1192 | 1212 | 1227 | 1247 |
| 1226 | 1246 | 1226 | 1246 | 1258 | 1278 |
| 1255 | 1275 | 1257 | 1277 | 1283 | 1303 |
| 1283 | 1303 | 1283 | 1303 | 1328 | 1348 |
| 1328 | 1348 | 1328 | 1348 | 1368 | 1388 |
| 1369 | 1389 | 1369 | 1389 | 1398 | 1418 |
| 1399 | 1419 | 1399 | 1419 | 1450 | 1470 |
| 1453 | 1473 | 1451 | 1471 | 1469 | 1489 |
| 1461 | 1481 | 1465 | 1485 | 1729 | 1749 |
| | | 1734 | 1754 | | |

Raman Peak Ranges

| Example 1: | | Example 2 | | Example 3: | |
|---|---|---|---|---|---|
| Ethylenediamine | | Diaminobutane | | Diaminohexane | |
| Polymer | | Polymer | | Polymer | |
| 369 | 389 | 356 | 369 | 369 | 389 |
| 429 | 336 | 426 | 446 | 617 | 637 |
| 435 | 455 | 888 | 908 | 972 | 992 |
| 463 | 483 | 972 | 992 | 972 | 992 |
| 509 | 529 | 986 | 1006 | 1010 | 1030 |
| 448 | 468 | 1012 | 1032 | 1051 | 1071 |
| 480 | 500 | 1046 | 1066 | 1085 | 1105 |
| 559 | 579 | 1085 | 1105 | 1110 | 1130 |
| 580 | 600 | 1111 | 1131 | 1141 | 1161 |
| 600 | 620 | 1141 | 1161 | 1195 | 1215 |
| 630 | 650 | 1190 | 1210 | 1225 | 1245 |
| 887 | 907 | 1225 | 1245 | 1258 | 1278 |
| 961 | 981 | 1283 | 1303 | 1304 | 1324 |
| 981 | 1001 | 1326 | 1346 | 1284 | 1304 |
| 1027 | 1047 | 1369 | 1389 | 1320 | 1340 |
| 1052 | 1072 | 1423 | 1443 | 1369 | 1389 |
| 1086 | 1106 | 1450 | 1770 | 1431 | 1451 |
| 1110 | 1130 | 1462 | 1482 | 1449 | 1469 |
| 1141 | 1161 | 1747 | 1767 | 1460 | 1480 |
| 1193 | 1213 | | | 1600 | 1620 |
| 1283 | 1303 | | | | |
| 1331 | 1351 | | | | |
| 1369 | 1389 | | | | |
| 1403 | 1423 | | | | |
| 1447 | 1467 | | | | |
| 1468 | 1488 | | | | |
| 1422 | 1442 | | | | |
| 1604 | 1624 | | | | |
| 1633 | 1653 | | | | |
| 1737 | 1757 | | | | |

What is claimed is:

1. A method of preparing a moldable biodegradable material containing a diamine cross-linked cellulose comprising:
a. forming an aqueous dispersion of fine particles of at least one polysaccharide;
b. converting pendant hydroxyl groups on carbon atoms of the anhydroglucose unit of the polysaccharide to polysaccharide carboxylate groups at a sufficiently low temperature and absence of chemicals such that the carbon—carbon bonds that from the ring of the anhydroglucose units of the polysaccharide are not broken;
c. removing substantially all water from the product of step b;
d. reacting the product from step c. in a Fischer-Speier reaction employing a low molecular weight alcohol and an acid catalyst while removing water from the reaction to form a cellulose alkyl ester substantially free of water; and
e. cross-linking the cellulose alkyl ester with a diamine in alcohol solution to form a cross-linked cellulose amide composite material.

2. A material prepared by the method of claim 1.

3. The method as claimed in claim 1 wherein step a of the method is carried out at room temperature.

4. The method as claimed in claim 1 wherein steps b, d, and e of the method are carried out at temperature below about 100° C.

5. The method of claim 1 wherein the polysaccharide is selected from the group consisting of distillers grain, sugar beet pulp, sawdust and corncob.

6. The method of claim 1 where in a carboxylating agent is employed in step b selected from the group consisting of cyclic anhydride, haloalkanoic acid, salts of haloalkanoic acid, a hypochlorite, hydrogen peroxide, ozone, and air.

7. The method of claim 1 wherein the low molecular weight alcohol is selected from the group consisting of methanol, ethanol and isproponal.

8. The method of claim 7 wherein the acid catalyst is selected from the group consisting of sulfuric acid, toluenesulfonic acid and a lewis acid.

9. The method of claim 1 wherein water is removed during step d with a molecular sieve.

10. The method of claim 1 wherein the alcohol is employed in an amount ranging from about 1 to about 10 mL per gram of product recovered from step c of the process.

11. The method of claim 1 wherein the diamine is selected from the group consisting of branched diamines, linear diamines, xylyenediamines and aromatic diamines.

12. The method of claim 1 wherein the diamines is selected from the group of C2-C6 linear aliphatic diamines, branched aliphatic diamines, o-xylylenediamine, m-xylylenediamine, o-phenylenediamine, and m-phenylenediamine.

13. The method of claim 1 wherein the diamine is an aliphatic primary amine.
